(19) United States
(12) Patent Application Publication
(10) Pub. No.: US 2007/0152889 A1
(43) Pub. Date: Jul. 5, 2007

(54) Portable Wireless Communication Apparatus

(76) Inventors: Chin-Hao Chen, Taipei (TW); Chen-Ming Chiang, Taipei (TW); Chun-Chen Chao, Taipei (TW)

Correspondence Address: LAW OFFICES OF LAI & ASSOCIATES, P.C., 5800 RANCHESTER STE 200, HOUSTON, TX, 77036, US

(21) Appl. No.: 11/556,884

(22) Filed: Nov. 6, 2006

(30) Foreign Application Priority Data
Jan. 4, 2006 (TW) 0952 00181

(51) Int. Cl. H01Q 1/24

(52) U.S. Cl. 343/702

(57) ABSTRACT

A portable wireless communication apparatus comprises a circuit board, an antenna and a casing. The circuit board comprises a plurality of electronic components. The antenna is electrically connected to the circuit board for implementing wireless communication. The circuit board is covered by the casing to isolate noise generated by the electronic components and the wireless communication jammed by the noises can be avoided.

### FIELD OF THE INVENTION

The present invention relates to a portable wireless communication apparatus, and more particularly to the portable wireless communication that isolates a noise generated by electronic components.

### BACKGROUND OF THE INVENTION

A conventional portable wireless communication apparatus usually has a lot of electronic components that may generate Radio Frequency (RF) emissions as noise. The noise may interfere with wireless communication performed by antennas to lower the transmission and receiving efficiencies of a wireless network. Referring to FIG. 1, a block diagram illustrates a conventional portable wireless communication apparatus. The portable wireless communication apparatus 10 includes a circuit board 11 and an antenna 12. The circuit board 11 includes a plurality of electronic components 111. The antenna 12 is electrically connected to the circuit board 11 for performing a wireless communication 121. However, the electronic components 111 disposed on the circuit board 11 would generate noise 1111 that interferes with the wireless communication 121 performed by the antenna 12.

Referring to FIG. 2, a block diagram illustrates a conventional portable wireless communication apparatus. The portable wireless communication apparatus takes a tablet personal computer 20 as an example. The tablet personal computer 20 includes a motherboard 21 and a Bluetooth antenna 22. The motherboard 21 includes a central processor 211, a clock generator 212 and a memory 213. The central processor 211, the clock generator 212 and the memory 213 generate a first RF emission 2111, a second RF emission 2121 and a third RF emission 2131 respectively. The Bluetooth antenna 22 is electrically connected to the motherboard 21 for performing a Bluetooth communication 221. However, the first RF emission 2111, the second RF emission 2121 and the third RF emission 2131 may interfere with the Bluetooth antenna 22 to influence the transmission efficiency of the Bluetooth communication 221.

To isolate the noise generated by the electronic components, the inventor of the present invention based on years of experience on related research and development invents a portable wireless communication apparatus to overcome the foregoing shortcomings.

### SUMMARY OF THE INVENTION

Accordingly, an object of the present invention is to provide a portable wireless communication apparatus. The portable wireless communication apparatus could isolate a noise generated by an electronic apparatus.

To achieve the foregoing object, the portable wireless communication apparatus includes a circuit board, an antenna and a casing. The circuit board includes a plurality of electronic components. The antenna is electrically connected to the circuit board for performing a wireless communication. The casing covers the circuit board for isolating the noise generated by the electronic components to prevent the noise from interfering with the wireless communication performed by the antenna. The wireless communication can be a Bluetooth communication, a Wireless Local Area Network (WLAN) communication or other communication protocols performing data transmission through any wireless way.

The portable wireless communication apparatus of the present invention uses the casing to cover the circuit board. The noise generated by the electronic components on the circuit board can be isolated. The wireless communication performed by the antenna can have higher transmission and receiving efficiencies.

Other features and advantages of the present invention and variations thereof will become apparent from the following description, drawings, and claims.

### BRIEF DESCRIPTION OF THE DRAWINGS

FIG. 1 is a block diagram illustrating a conventional portable wireless communication apparatus;

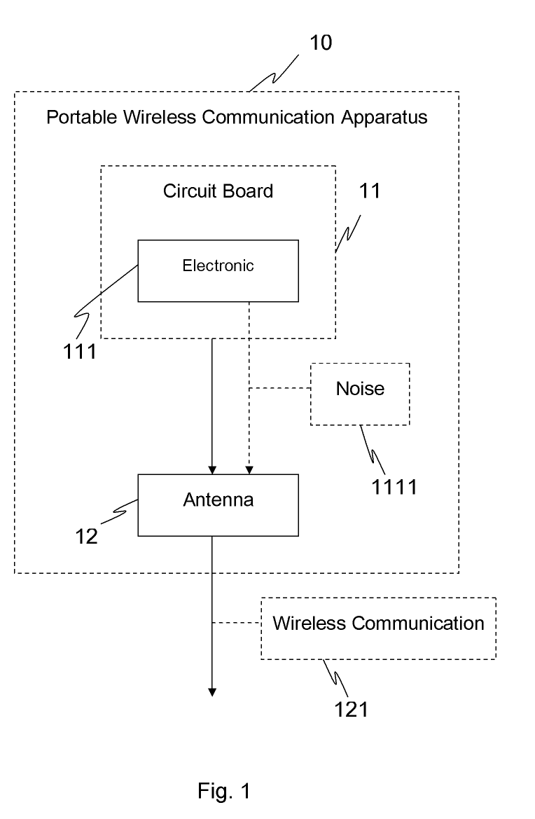

FIG. 2 is a block diagram illustrating a conventional portable wireless communication apparatus according to a preferred embodiment;

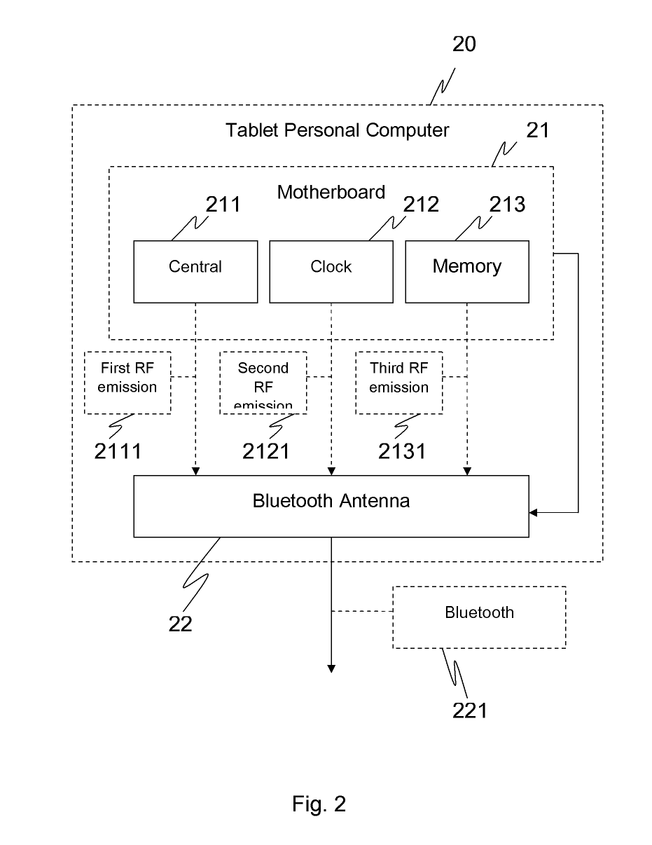

FIG. 3 is a block diagram illustrating a portable wireless communication apparatus according to an embodiment of the present invention; and

FIG. 4 is a block diagram illustrating a portable wireless communication apparatus according to a preferred embodiment of the present invention.

### DETAILED DESCRIPTION OF THE PREFERRED EMBODIMENTS

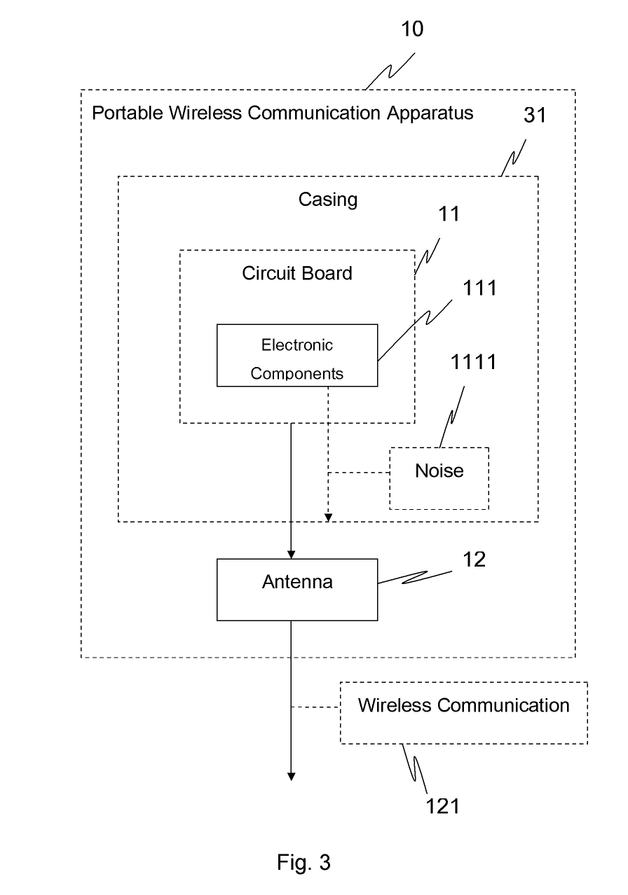

Referring to FIG. 3, a block diagram illustrates a portable wireless communication apparatus according to an embodiment of the present invention. The portable wireless communication apparatus 10 includes the circuit board 11, the antenna 12 and a casing 31. The circuit board 11 includes the plurality of electronic components 111. The antenna 12 is electrically connected to the circuit board 11 for performing the wireless communication 121. The casing 31 covers the circuit board 11 for isolating the noise 1111 generated by the electronic components 111 to prevent the noise 1111 from interfering with the wireless communication 121 performed by the antenna 12.

The circuit board 11 is a motherboard disposed in the portable wireless communication apparatus 10. The noise 1111 is a Radio Frequency emission (RF) generated by the electronic components 111. The casing 31 is a material for isolating electric waves. The antenna 12 is a Bluetooth antenna, a Wireless Local Area Network (WLAN) antenna or other antennas for performing the wireless communication. The wireless communication 121 is a Bluetooth communication, a WLAN communication or other communication protocols for performing data transmission by using any wireless way. The portable wireless communication apparatus 10 is a tablet personal computer, a notebook computer, a Personal Digital Assistant (PDA) or other wireless communication devices with antennas.

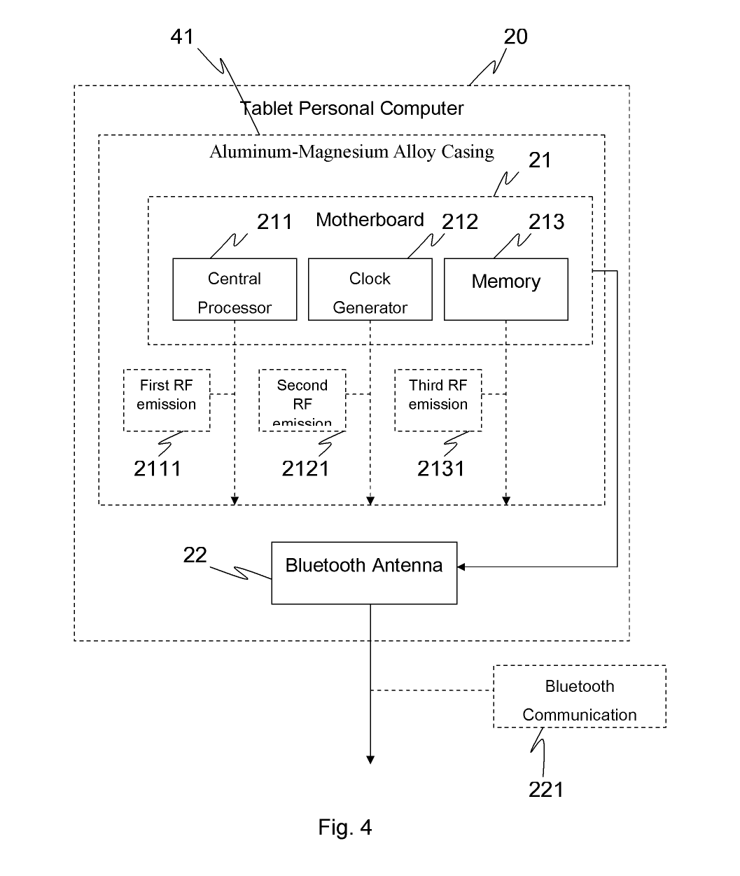

Referring to FIG. 4, a block diagram illustrates a portable wireless communication apparatus according to a preferred embodiment of the present invention. The portable wireless communication apparatus takes the tablet personal computer 20 as an example that includes the printed circuit board 21, the Bluetooth antenna 22 and an aluminum-magnesium alloy casing 41. The printed circuit board 21 includes the central processor 211, the clock generator 212 and the memory 213. The central processor 211, the clock generator 212 and the memory 213 generates the first RF emission 2111, the second RF emission 2121 and the third RF emission 2131 respectively. The Bluetooth antenna 22 is electrically connected to the printed circuit board 21 for performing the Bluetooth communication 221. The aluminum-magnesium alloy casing 41 covers the printed circuit board 21 for isolating the first RF emission 2111, the second RF emission 2121 and the third RF emission 2131. Therefore, the first RF emission 2111, the second RF emission 2121 and the third RF emission 2131 will not interfere with the Bluetooth antenna 22 to improve the transmission efficiency of the Bluetooth communication 221.

Although the features and advantages of the embodiments according to the preferred invention are disclosed, it is not limited to the embodiments described above, but encompasses any and all modifications and changes within the spirit and scope of the following claims.

What is claimed is:

1. A portable wireless communication apparatus, comprising:
a circuit board having a plurality of electronic components;
an antenna electrically connected to said circuit board to perform a wireless communication; and
a casing for covering up said circuit board for isolating noise generated by said electronic components to prevent said noise from interfering with said wireless communication performed by said antenna.

2. The portable wireless communication apparatus of claim 1, wherein said circuit board is a printed circuit board of said portable wireless communication apparatus.

3. The portable wireless communication apparatus of claim 1, wherein said noise is radio frequency (RF) emission generated by said electronic components.

4. The portable wireless communication apparatus of claim 1, wherein said casing is a material for isolating electric waves.

5. The portable wireless communication apparatus of claim 1, wherein said antenna is a Bluetooth antenna or a Wireless Local Area Network (WLAN) antenna.

6. The portable wireless communication apparatus of claim 1, wherein said wireless communication is Bluetooth communication or WLAN communication.

7. The portable wireless communication apparatus of claim 1, wherein said portable wireless communication apparatus is a tablet personal computer (Tablet PC).

8. The portable wireless communication apparatus of claim 1, wherein said portable wireless communication apparatus is a notebook computer.

9. The portable wireless communication apparatus of claim 1, wherein said portable wireless communication apparatus is a Personal Digital Assistant (PDA).
